(19) United States
(12) Patent Application Publication
(10) Pub. No.: US 2010/0187766 A1
(43) Pub. Date: Jul. 29, 2010

(54) HARD CHROME LAYER, COATED SUBSTRATE, AND TRIBOLOGICAL SYSTEM

(76) Inventors: Monika Raible Lehnert, Remseck (DE); Kurt Maier, Leonberg (DE)

Correspondence Address: COLLARD & ROE, P.C., 1077 NORTHERN BOULEVARD, ROSLYN, NY, 11576, US

(21) Appl. No.: 12/733,102

(22) PCT Filed: Aug. 8, 2008
(86) PCT No.: PCT/DE2008/001311

§ 371 Date: Mar. 9, 2010

(30) Foreign Application Priority Data
Aug. 10, 2007 (DE) 10 2007 037 778.0

(51) Int. Cl. F16J 9/26; B32B 5/16; C25D 15/00; F16J 9/00

(52) U.S. Cl. 277/444; 428/323

(57) ABSTRACT

The present invention relates to a hard chrome layer, which is formed substantially by electrodeposition from an electrolyte containing a hexavalent chrome and which has fissures in which particles of hard material are intercalated. According to the invention, it is provided that the particles of hard material are formed from cubic boron nitride and have an average particle size of from 0.1 to 1.0 μm. The present invention also relates to a substrate with such a hard chrome layer and to a tribological system comprising a basic body and an opposing body in the form of such a substrate.

The present invention relates to a hard chrome layer that is formed essentially by means of galvanic deposition from an electrolyte containing hexavalent chrome and that has cracks in which the hard substance particles are embedded. The present invention furthermore relates to a substrate coated with such a hard chrome, and to a tribological system having a base body and such a substrate as a counter-body.

A hard chrome layer of the, type stated is known from DE 199 31 829 A1. DE 199 31 829 relates to piston rings coated with a hard chrome layer of the type stated, which interact with cylinder working surfaces in motor vehicle engines, in a tribological system. The hard chrome layer disclosed there contains diamond particles having a size in the range of 0.25 to 0.5 μm as hard substance particles. In practice, while comparatively low wear is observed on the piston ring when using such hard chrome layers, increased wear is observed on the cylinder working surface. Furthermore, it turned out that contrary to expectations, it was not possible to improve the scuff resistance.

Within the scope of the present disclosure, the term “scuffs” is understood to mean surface changes that are caused by great thermal stress on the surface. In particular, dark discolorations, which occur in new engines after relatively short running times, in most cases, can be observed on the ring working surface. These scuffs are precursors of ring side scoring. They are expressed, at first, in the occurrence of macro-cracks in the hard chrome layer. However, for safe engine operation, in practice, it is very important to design engine and components in such a manner that the occurrence of scuffs is prevented as much as possible, even under difficult operating conditions.

A hard chrome layer of the type stated is furthermore known from EP 0 217 126 A1. Aluminum oxide (Al₂O₃) particles are embedded into the hard chrome layers described there. They serve to coat the first compression ring in diesel engines. However, in the case of modern diesel engines, which are subject to great stress, sufficient scuff resistance is no longer guaranteed by such hard chrome layers. Furthermore, after extended running times, noticeable layer wear occurs, leading to a reduction in the outside diameter of the piston ring. As a result, a larger gap occurs at the butt ends of the piston ring, which gap leads to increased oil consumption and an increased blow-through amount. Both effects increase the environmental pollution caused by the engine and are therefore undesirable.

The present invention is based on the task of optimizing a hard chrome layer of the type stated, in such a manner that the wear resistance of the tribological system that contains the hard chrome layer is improved. In particular, the wear resistance of the hard chrome layer applied to a piston ring is supposed to be further optimized and, at the same time, the wear on the corresponding cylinder is supposed to be reduced. Furthermore, the scuff resistance is also supposed to be improved.

The solution consists in a hard chrome layer having the characteristics of claim 1. According to the invention, it is provided that the hard substance particles are formed from cubic boron nitride and have an average particle size of 0.1 to 1.0 μm. Furthermore, a substrate provided with a hard chrome layer according to the invention is an object of the present invention. Finally, a tribological system composed of a base body consisting of an iron-based material, and of a counter-body in the form of a substrate according to the invention, is an object of the present invention.

It turned out, completely surprising to a person skilled in the art, that not only is the scuff resistance clearly improved with the hard chrome layer according to the invention, but also the wear values both on the base body and on the counter-body of the tribological system (in other words both on the cylinder and on the piston ring, for example) are reduced.

Cubic boron nitride has a Knoop hardness of 4,500 and a density of 3.48 g/cm³. It is thermally resistant to above 1,200° C. Thus, its thermal resistance is better than that of diamonds, which tend to give off carbon under thermal stress. This was considered an advantage up to now, since additional solid lubrication was supposedly connected with it. Surprisingly, the higher thermal resistance of cubic boron nitride is obviously the reason for the improved scuff resistance when using the hard chrome layer according to the invention in tribological systems.

The particle size of the hard substance particles composed of cubic boron nitride results from the circumstance that particles that are larger than 1 μm, on average, are too large to be able to embed themselves into the cracks formed in the hard chrome layer. Furthermore, large hard substance particles contribute to greater wear in the tribological system. Particles that are smaller than 0.1 μm, on average, make no contribution to improving the wear resistance or scuff resistance.

Advantageous further developments are evident from the dependent claims.

In an advantageous further development, the average particle size of the hard substance particles amounts to 0.3 μm. In this way, the wear resistance and the scuff resistance can be further optimized.

The hard chrome layer according to the invention can contain 0.5 to 5.0 wt.-%, preferably 1.0 to 3.0 wt.-% hard substance particles, with reference to the entire layer, in order to achieve particularly good wear resistance and scuff resistance.

The hard chrome layer according to the invention preferably consists of a sequence of individual layers. In this way, uniform distribution of the hard substance particles is achieved. It is practical if the thickness of the individual layers is 10 to 20 μm, preferably 12 to 16 μm, particularly preferably 14 μm, in each instance. The number of individual layers then results from the total layer thickness selected.

The total layer thickness of the hard chrome layer can amount to 100 to 200 μm, preferably 130-180 μm, after galvanic deposition. The layer thickness should be great enough to permit final machining, for example by means of grinding. The finished, machined hard chrome layer can have a layer thickness of 50 to 150 μm, preferably 80-120 μm, for example.

The hard chrome layer according to the invention is suitable for all tribological systems. In this connection, it has proven to be a particularly great advantage of the hard chrome layer according to the invention that it can be combined in a tribological system with numerous materials on the basis of iron. These include not only materials on the basis of lamellar cast iron, which are usual as a cylinder material. The hard chrome layer according to the invention can also be combined with materials composed of vermicular or globulitic cast iron, as well as with materials on the basis of steel, for example. In the practical application in the tribological system composed of piston ring and cylinder, the materials spectrum for the cylinders is significantly expanded in this way.

An exemplary embodiment of the invention will now be explained in greater detail.

Piston rings composed of cast iron, taken from standard production, were used as substrates and provided with the hard chrome layer according to the invention by means of galvanic coating. In this connection, the method of procedure was that indicated according to EP 0 217 126 A1, whereby the electrolyte was mixed with particles of cubic boron nitride having an average particle size of 0.3 μm. The particles of cubic boron nitride were continuously kept in suspension during the coating process, by means of stirring. The electrolyte temperature was 55° C.

The following electrolyte composition was used:
Chromic acid (CrO₃) 300 g/l
Sulfuric acid 3 g/l
Potassium fluoride 1 g/l
Methane sulfonic acid 4 g/l
Cubic boron nitride 20 g/l

The hard chrome layer according to the invention was built up from a sequence of individual layers. Each individual layer was deposited at a current density of 120 A/dm² and a coating time of 12 min, whereby the substrates were switched to be cathodic. Afterwards, the substrates were switched to be anodic and etched at a current density of 60 A/dm² for 90 s. In this connection, the cracks that naturally occur in the individual layer were widened. The hard substance particles of cubic boron nitride dispersed in the electrolyte embedded themselves into the cracks.

The steps of coating and etching as described were repeated 14 times. Subsequently, a final coating layer was applied without any subsequent etching step. The total layer thickness amounted to about 180 μm in the deposition state, i.e. immediately after termination of the galvanic deposition.

The piston rings coated in this manner were ground on their working surface, in known manner. The layer thickness of the hard chrome layer according to the invention amounted to about 120 μm after grinding.

In a comparison with hard chrome layers known in the state of the art, the wear resistance of the hard chrome layer according to the invention was compared with embedded hard substance particles having a similar size, namely aluminum oxide particles (Version A, Version B), on the one hand, and with diamond particles, on the other hand. For this purpose, a usual tribometer was used, which produces reversing slide wear. A segment of a piston ring coated according to the invention as well as a segment of a corresponding honed cylinder of lamellar cast iron were used as test parts. With this arrangement, the movement of the piston ring on the cylinder, specifically in the wear-relevant region of the upper reversal point, was depicted. Accordingly, the test conditions were chosen to be such that a great load and thus a great surface pressure acted on the test arrangement, at a slow movement and the lowest possible lubricant oil supply, corresponding to the gas pressure acting on the ring during engine operation. The test conditions were, in detail:

| Test period: | 12 | h |
|---|---|---|
| Load: | 1,200 | N |
| Surface pressure: | 57 | N/mm² |
| Stroke: | 4 | mm |
| Speed: | 1.33 | m/minHz |
| Frequency: | 5 | Hz |
| Lubrication: | 0.036 g every 2 hours | |
| Oil: | engine oil 5 W 40 | |
| Temperature: | 20° | C. |

The test results are shown in Table 1.

TABLE 1

| Hard chrome layer | Wear on the | Wear on the | Friction |
|---|---|---|---|
| used | ring [μm] | cylinder [μm] | coefficient |
| Exemplary | 0.4 | 0.8 | 0.09-0.13 |
| embodiment | | | |
| Al₂O₃ particles, | 1.2 | 5.8 | 0.08-0.15 |
| Version A | | | |
| Al₂O₃ particles, | 1.3 | 2.8 | 0.06-0.16 |
| Version B | | | |
| Diamond particles | 0.5 | 1.4 | 0.06-0.11 |

These results clearly show that the hard chrome layer according to the invention, with embedded hard substance particles of cubic boron nitride, demonstrates the lowest wear, not only on the piston ring but also on the cylinder.

The scuff resistance was tested in a special engine test, in a four-cylinder diesel engine. Lamellar cast iron was used as the cylinder material. The test conditions were designed to increase the surface temperature on the working surface of the piston ring, as compared with the standard production state of the engine, in such a manner that the occurrence of scuffs is promoted. In order to achieve this, some components of the engine were geometrically modified as compared with the standard production state, and the average operating temperatures of the engine were artificially increased. In this way, it was possible to reproducibly produce scuffs after only short running times. The scuff resistance was evaluated visually.

The test results are summarized in Table 2.

TABLE 2

| Hard chrome layer | Cylinder | Cylinder | Cylinder | Cylinder |
|---|---|---|---|---|
| used | 1 | 2 | 3 | 4 |
| Exemplary | no scuffs | no scuffs | slight | no scuffs |
| embodiment | | | scuffs | |
| Al₂O₃ particles | no scuffs | slight | no scuffs | strong |
| | | scuffs | | scuffs |
| Diamond particles | no scuffs | slight | slight | strong |
| | | scuffs | scuffs | scuffs |

In this test, cylinders 3 and 4 demonstrated the greatest formation of scuffs, because they have the highest temperatures. The test results clearly show that the hard chrome layer according to the invention, with embedded hard substance particles of cubic boron nitride, produces clearly improved scuff resistance as compared with the comparison examples.

1. Hard chrome layer that is formed essentially by means of galvanic deposition from an electrolyte containing hexavalent chrome and that has cracks in .which the hard substance particles are embedded, wherein the hard substance particles are formed from cubic boron nitride and have an average particle size of 0.1 to 1.0 μm.

2. Hard chrome layer according to claim 1, wherein the average particle size of the hard substance particles amounts to 0.3 μm.

3. Hard chrome layer according to claim 1, wherein it contains 0.5 to 5.0 wt.-%, preferably 1.0 to 3.0 wt.-% hard substance particles, with reference to the entire layer.

4. Hard chrome layer according to claim 1, wherein it consists of a sequence of individual layers.

5. Hard chrome layer according to claim 4, wherein the thickness of the individual layers amounts to 10-20 μm, preferably 12-16 μm.

6. Hard chrome layer according to claim 1, wherein its layer thickness after galvanic deposition amounts to 100 to 200 μm, preferably 130-180 μm.

7. Hard chrome layer according to claim 1, wherein its layer thickness after a machining process amounts to 50 to 150 μm, preferably 80-120 μm.

8. Substrate having a hard chrome layer according to claim 1.

9. Substrate according to claim 8, namely a piston ring.

10. Tribological system composed of a base body and a counter-body, wherein the base body consists of a material based on iron, and wherein the counter-body is a substrate according to claim 9.

11. Tribological system according to claim 10, wherein the base body consists of a material on the basis of cast iron with a lamellar, vermicular, or globulitic graphite configuration.

12. Tribological system according to claim 10, wherein the base body consists of a material on the basis of steel.

13. Tribological system according to claim 10, having a cylinder of an engine block of a motor vehicle engine as the base body and a piston ring as the counter-body.
